(19) United States
(12) Patent Application Publication
(10) Pub. No.: US 2018/0154545 A1
(43) Pub. Date: Jun. 7, 2018

(54) METHOD AND APPARATUS FOR MANUFACTURING SHAKES

(71) Applicant: Anbrook Industries Ltd., Pitt Meadows (CA)

(72) Inventor: Brooke MEEKER, Mission (CA)

(73) Assignee: Anbrook Industries Ltd.

(21) Appl. No.: 15/371,116

(22) Filed: Dec. 6, 2016

(51) Int. Cl. B27C 5/00; B27M 3/02; E04D 1/22; E04F 13/10

(52) U.S. Cl. CPC B27C 5/00; E04F 13/10; E04D 1/22; B27M 3/02

(57) ABSTRACT

An apparatus for profiling a shake, includes two opposed sets of rollers configured and arranged to support a wooden blank and to transport the wooden blank from an infeed end of the apparatus to an outfeed end of the apparatus along a transport path, the wooden blank having a pair of opposed major faces, and a pair of opposed rotatable cutting heads, configured and arranged to engage the major faces of the wooden blank as it is conveyed through a cutting region of the transport path, wherein each of the cutting heads comprises a plurality of knives having respective varied profiles such that as the wooden blank passes between the cutting heads, a selected profile is imparted to each of the major faces.

### FIELD

The description herein relates generally to systems and methods for shaping a wood product, and more particularly to such systems and methods for manufacturing shakes and shingles.

### BACKGROUND

Shakes are building material products used in roofing and siding, for example. Historically, shakes were split from cedar or other softwoods, but modern shake manufacture has adopted an approach using a hydraulic cuber to split a wood blank and then pass the blank through an automatic saw on a diagonal to produce two tapered pieces, each with one naturally split face and one sawn back. This process is referred to as a resaw operation. One example of a device for resawing shakes is in U.S. Pat. No. 4,291,601 to Gunyup.

Naturally split shakes have rough surface features that reflect the manufacturing process. This provides a more rustic and natural appearance with random peaks and valleys along the exposed face of the product.

Sawn shakes are typically smoother in appearance. Because it may be desirable to provide the rustic appearance of a split shake in a product having the reproducibility and efficiency of manufacture of a sawn shake, there have been systems and methods for sawing grooves into the display surface of the shake. These can tend to result in a shake that has a machined appearance that, despite the grooves, still appears unnatural to the consumer.

### SUMMARY

In an embodiment, an apparatus for profiling a shake includes two opposed sets of rollers configured and arranged to support a wooden blank and to transport the wooden blank from an infeed end of the apparatus to an outfeed end of the apparatus along a transport path, the wooden blank having a pair of opposed major faces, and a pair of opposed rotatable cutting heads, configured and arranged to engage the major faces of the wooden blank as it is conveyed through a cutting region of the transport path, wherein each of the cutting heads comprises a plurality of knives having respective varied profiles such that as the wooden blank passes between the cutting heads, a selected profile is imparted to each of the major faces

In an embodiment, there is provided a method of manufacturing a shake comprising passing a wooden blank through the cutting region of the foregoing apparatus.

In an embodiment, there is provided a machine readable medium comprising machine executable instructions for manufacturing a shake in accordance with the foregoing method.

### BRIEF DESCRIPTION OF THE DRAWINGS

FIG. 1 is a plan view of a profiling machine in accordance with an embodiment of the invention;

FIG. 2 is an end view of a cutting head in accordance with an embodiment of the invention;

FIG. 3 is an elevation view of the cutting head of FIG. 2;

FIG. 4a is an elevation view of a knife of the cutting head of FIG. 2 and FIG. 4b is an end view of the knife of FIG. 4a; and

FIG. 5 is a schematic plan view of a cutting region in a climb cutting configuration in accordance with an embodiment of the invention.

### DETAILED DESCRIPTION OF THE DRAWINGS

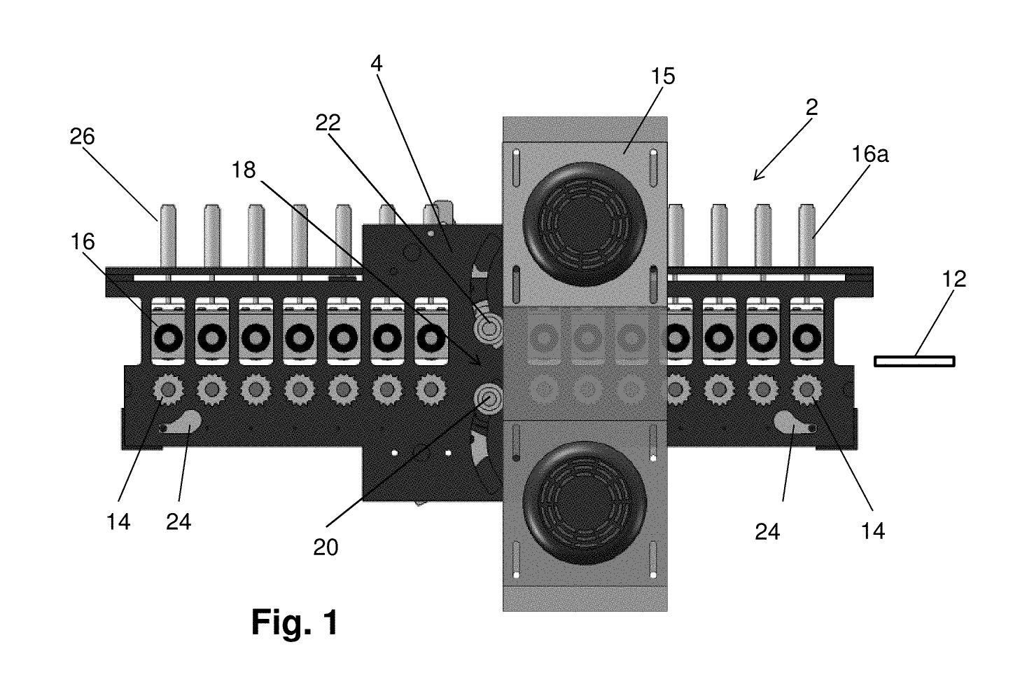

FIG. 1 is a top plan view of a profiling apparatus 2 in accordance with an embodiment of the invention. A top plate 4 forms an upper surface of the apparatus, and includes a number of openings to allow motion of various components to be described below. A corresponding bottom plate, not shown, may have a similar structure. In an embodiment, the top plate may be manufactured from a thick steel plate, for example, a one inch thick steel plate.

Wooden blanks 12, being substantially parallelepiped in form and having two opposed major faces, and four minor faces, may be fed into an infeed region of the apparatus in a vertical orientation. The wooden blanks 12 may be, for example, pressure treated or otherwise preserved. In principle, engineered materials could be used in place of wood. A typical blank may measure approximately 24″ long and 1.25″ thick with a width ranging from 4″ to an unlimited width.

The structure and function of the infeeding conveyor is not material to the operation of the profiling apparatus, and may be of conventional construction, with the caveat that the infeeding apparatus should provide the wooden blanks in the vertical orientation so that they may properly be taken in by the front set of rollers.

The wooden blanks 12 are conveyed through the profiling apparatus by opposed pairs of vertically oriented rollers that engage the major faces of the blanks. A first set of rollers on one side are fixed rollers 14 while the opposed set of rollers are floating rollers 16. As will be appreciated, the floating rollers may, in principle, be fixed, however the floating arrangement provides additional functionality in the form of improved ability to handle wooden blanks of varying thicknesses. The rollers may be metal, e.g., steel, machined from 2″ diameter stock and having a rubber outer covering to form a 3″ diameter roller.

An amount of pressure exerted by the floating rollers 16 can be adjusted to ensure that the wooden blank 12 is held tightly as it is conveyed through the device.

In operation, the conveyor feeds the wooden blank 12 in between a pair of opposed cutting heads that are vertically oriented in a cutting region 18. Blanks may be processed at a rate of about 10-40 per minute, more particularly about 20-30 per minute and, more particularly 25 blanks per minute. That is, about 50 finished pieces of product after it has passed through the resaw after the blank has been profiled. The cutting heads machine the desired profile into both major faces of the wooden blank 12 as it is passed between them. Each side may be configured to produce a same profile or to produce a different profile. Similarly, on a manufacturing floor, different machines may be configured to produce different profiles from each other, or different batches may use different cutting heads in order to produce different profiles. In this way, a package of shakes to be sold may incorporate several different profiles so that in application a varied appearance is produced.

The conveyor rollers 14, 16 continue to pass the wooden blank 12 to the outfeed, where it can be passed on to a corresponding resaw apparatus to be diagonally cut to complete the shake forming process. As with the infeeding conveyor, the resaw apparatus and its associated infeed mechanism may be conventional in nature. In an embodiment, the resaw blade may comprise part of the same apparatus rather than being a separate apparatus, the machines may be co-located in a cluster, or they may be entirely separate, such that profiled workpieces from the profiler 2 are not passed directly to a resawer but rather are held in an intermediate location. Likewise, an apparatus for forming the blanks from bulk lumber may form a part of the cluster on an infeed side of the shake profiler 2. Chain tensioners

Turning to the respective conveyor rollers, the fixed rollers 14 may be fixed in a substantially straight line. An electric motor and transmission, which may include a reducing gear arrangement, drive the rollers and are not illustrated.

A first cutting head 20 is located in line with the fixed rollers 14, at a gap in the line. The cutting head is adjustable toward or away from the centreline of travel of the wooden blanks 12 to modify the depth of cut, but is substantially fixed during operation. As will be appreciated, the cutting surfaces (described in greater detail below) are adjusted such that they are disposed closer to the centreline of the wooden blanks 12 than are the supporting rollers 14 so that an appropriate depth of cut may be achieved.

In an embodiment, the cutting head is driven via an electric motor located in housing 15, and optionally a drive belt, not shown. For example, the cutter head may rotate at a high rate of speed, such as a few thousand rpm. In an embodiment, the speed may be between about 3000 rpm and about 6000 rpm and more particularly about 5000 rpm.

The cutting head is configured to be adjustable, for example by use of an adjuster bolt and associated stop. In an embodiment, a pair of respective adjuster bolts and associated stops are located at each end of the cutter head, for example at the position of bearing mounts for the cutter head.

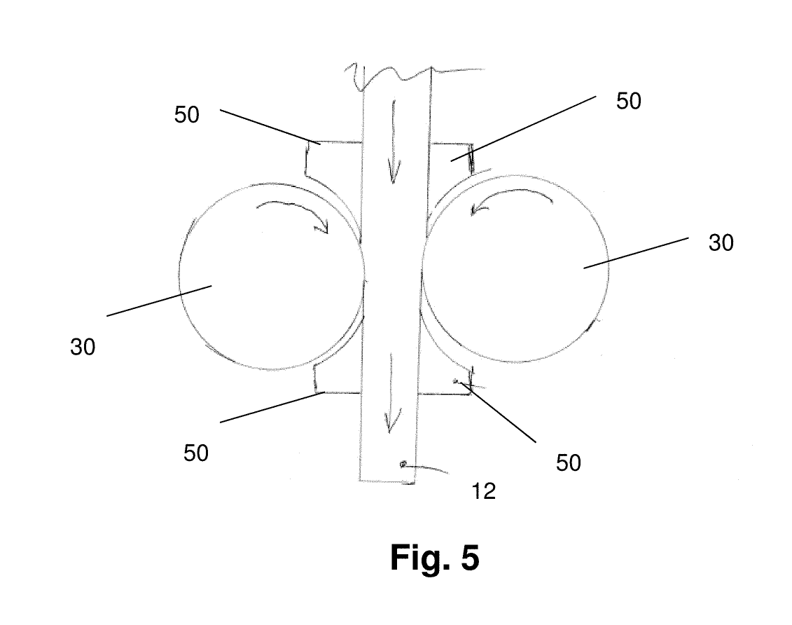

In order to stabilize the wooden blanks 12 as they pass through the cutter, a pair of shoes 50 (shown in FIG. 5), which may be, for example, steel, may be provided on either side of the cutter head, mounted vertically parallel to the cutter head. The shoes 50 may be adjustable in a horizontal direction by way of adjuster bolts and stops which may be positioned at top and bottom ends of the shoes 50. In an embodiment, the shoes 50 are adjusted such that they are at the plane of the cut and are intended to stabilize the workpiece and reduce or eliminate chatter during cutting.

A second cutting head 22 is located on the opposite side from the first cutter head 20 and substantially aligned with the floating rollers 16. As with the first cutter head 20, the second cutting head 22 is driven at high speed by an electric motor and is adjustable. Operation of the two cutting heads is substantially similar.

One distinction is that the second cutter head 22 may be mounted on a frame to allow it to be adjusted in alignment with the floating rollers and to allow for some floating with respect to the workpieces during operation. As with the first cutter head 20, the second cutter head 22 may be mounted with bearing mounts and vertical chatter-reducing shoes 50 that are adjustably mounted to control the depth of cut. For example, they may be set so that the cutting head is slightly proud of the shoes 50.

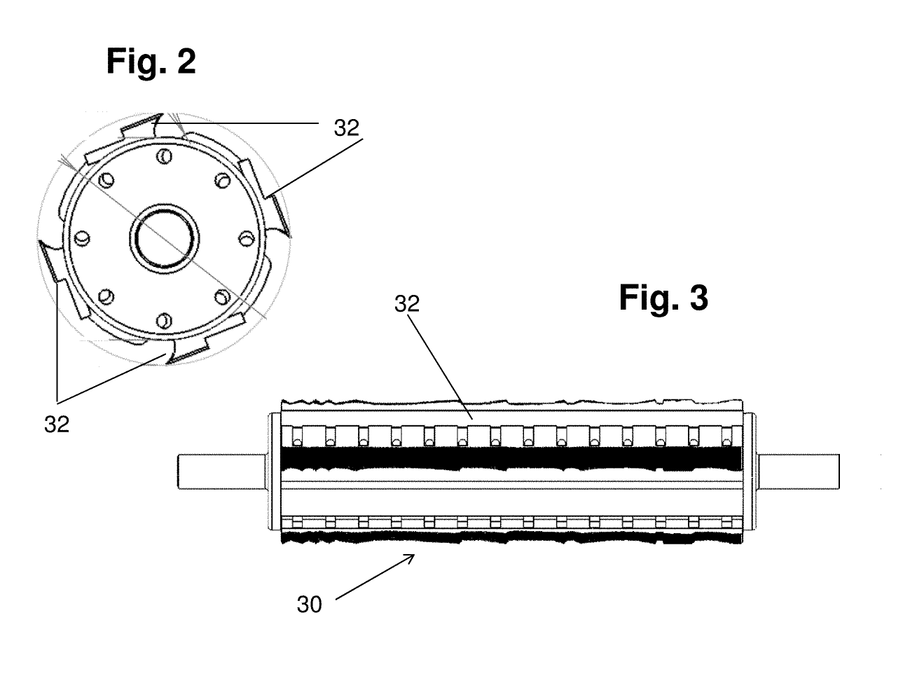

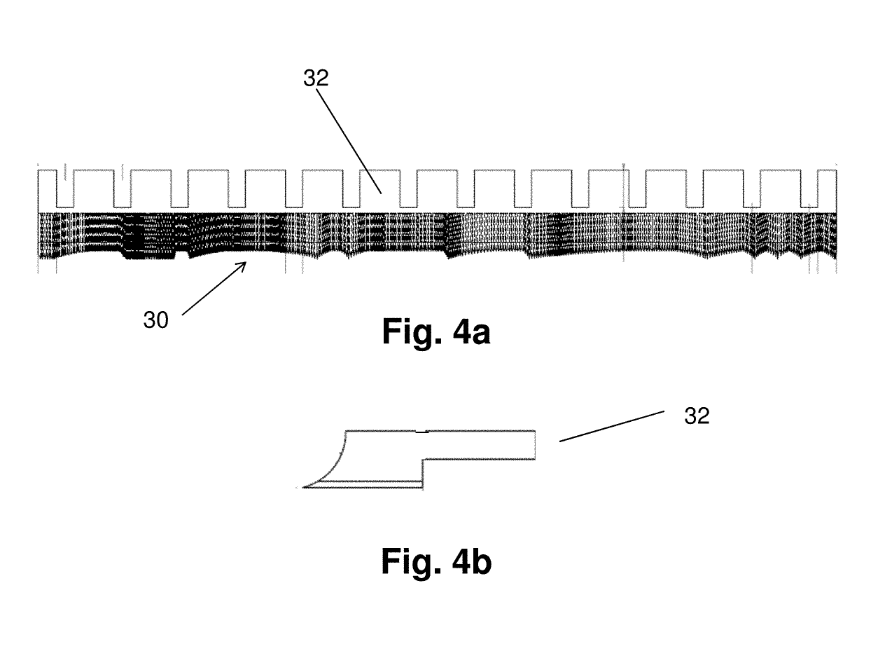

The cutting heads are illustrated in greater detail in FIGS. 2-4. FIG. 2 is an end view of a cutting head 20, 22. The blades may provide, for example, a cut on the order of 0.2 in. FIG. 3 is an elevation view of the cutter, showing the irregular profile 30 of each blade 32. A number of blades, for example, four, are arrayed around the cutting head and are removable and replaceable when worn or when a different profile is desired. Each blade may be of the type illustrated in FIG. 4a, and in an end view in FIG. 4b.

In part as a result of the use of four separated knives, which in an embodiment may have slightly different profiles, the cutting action includes brief gaps so that the profile becomes somewhat less clean cut than in a conventional circular blade. The use of a climb cutting technique can further enhance this effect by tearing through the wood as it is advanced. In a sense, the knives act to chip the wood away over a short region as the board passes through the cutting region 18. Because the knives are mounted on the roller, the depth of cut varies over the cutting region as the knives pass through the wood and as the wood passes through the cutting region. At a speed of 25 wood blanks per minute and a cutter head speed of 5000 rpm, for example, each of the knives will pass through approximately 0.03 linear inches of board face during each partial cut, varying the depth of the cut as it goes. Then, due to the space between knives, the next cut will not start exactly where the previous one ended, and it will cut a slightly different profile into the face of the blank 12. These two effects together may combine to produce grooves that have an improved, more natural look, with grooves that may extend along the full shake, from front to back as the blank 12 passes through the profiler. Alternately, it is possible to shift the cutting heads away from the blank and profile only a portion of the major surfaces.

Tensioners 24 are located at either end of the top plate 4. These allow adjustment of the tension in the drive belts that control the rollers, for example.

The floating rollers 16 may be idlers, though optionally they may also be driven. As will be appreciated, allowing the floating rollers to be idlers may allow simpler construction, as well as eliminating a requirement to ensure that the floating and fixed rollers be synchronized. In an embodiment, the first floating roller 16a at the infeed end is driven.

The floating rollers 16 are configured to allow some movement in the horizontal direction, accommodating different thicknesses of wooden blanks, warping, and other irregularities, for example.

Pressure against the wooden blank 12 may be provided by a variety of mechanisms. In an embodiment, one or more actuators is provided to move the floating rollers 16. For example, each actuator may comprise a pair of pneumatic pistons 26, one each at the top and bottom of each roller, is provided to generate a selected pressure and position for that roller. The pressure may be adjusted by adjusting the air pressure in the cylinders. Though a pneumatic piston is described as an embodiment, it will be appreciated that other approaches could provide the same function, including hydraulic pistons, electromagnetically adjustable pistons, spring biased pistons, or the like.

The driven infeed roller 16a may be adjustable using the same type of pneumatic piston system. The pistons 26 allow the first roll to be opened or closed in the horizontal direction to accommodate the intake of wooden blanks 12. An electronically controlled air valve may be connected to the pneumatic cylinders of the driven infeed roller 16a to control the position of the piston for opening and closing.

In operation, the driven infeed roller 16a is opened, allowing a wooden blank 12 to be fed into the profiler. It is closed, to press the wooden blank 12 against the opposed fixed roller 14, and the blank 12 is drawn into the profiler. It is passed along the opposed sets of rollers 14, 16 into the cutting area where the cutting heads, 20, 22 cut the desired profile into the surfaces.

The operation may be controlled with a programmable logic controller. (PLC) that may be coupled to a touch screen or other human machine interface device. The PLC may be configured to control, among other things, the electronically controlled air valve to control the horizontal movement of the driven infeed roller 16a. Likewise, logic may be included for controlling a pressure for each of the pneumatic pistons 26, the rate of rotation of the driven rollers, the speed of the cutter heads, and/or any of the included motors. Further, the PLC may control other units in the cluster, in the case where the resaw and/or other apparatus such as a planer or a saw for forming blanks are incorporated into a manufacturing cluster.

In an embodiment, the infeed is controlled to synchronize with the outfeed so that the wooden blanks 12, after profiling, are delivered to an automatic feed trough of the resaw apparatus. In one example, a short delay may be introduced to the timing of the air valve, for example 1/100s. This timing may likewise be implemented by way of appropriate code in the PLC.

The rolls may be set to feed the wooden blanks 12 through the machine at a rate slightly faster than the infeed conveyor speed. In order to implement this, the driven rolls may be driven using a variable frequency drive, that may likewise be controlled by the PLC. The speed differential may create a gap between wooden blanks 12 such that the outfeed spacing may be accommodated and synchronized with the resaw intake feed.

The PLC may also be configured to provide certain safety or efficiency functions. For example, the profiling apparatus 10 may be configured to incorporate an interlock to the resaw apparatus, ensuring that one does not run without the other being in proper operating condition. Similarly, the profiling apparatus 10 may be configured to shut down if a low pressure is detected in the pneumatic system, if a motor fault, jam, or other system failure is detected. Embodiments may include indicator lights to communicate the existence of a warning or fault condition. Alternately or in addition, the user interface may include written warning information including fault codes, error messages, or the like.

A thickness detecting function may be included to determine whether more than one wooden blank 12 is loaded simultaneously such that two blanks would enter the cutting region 18 at the same time. Likewise, in the case that the resaw apparatus includes a similar thickness detector that shuts its intake feed system down to prevent two wooden blanks 12 from being loaded simultaneously, the interlock system may induce a shut down of the feed system of the profiling apparatus 10.

In each case, any such shut down may include a warning and/or troubleshooting message to the operator via the interface or a warning/indicator light.

As will be appreciated by one of ordinary skill in the art, certain aspects of the the present application may be embodied as a system, method, or computer program product for use in operating a system. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in any one or more computer readable medium(s) having computer usable program code embodied thereon.

Computer code embodied on a computer readable medium may be transmitted using any appropriate medium, including but not limited to wireless, wireline, optical fiber cable, radio frequency RF, etc., or any suitable combination thereof.

Computer program code for carrying out operations for aspects of the present application may be written in any combination of one or more programming languages, including PLC operating code such as ladder logic, an object oriented programming language such as Java™, Smalltalk™, C++, or the like, and conventional procedural programming languages, such as the “C” programming language or similar programming languages.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The descriptions above are intended to be illustrative, not limiting. Thus, it will be apparent to one skilled in the art that modifications may be made as described without departing from the scope of the claims set out below.

1. An apparatus for profiling a shake, comprising:
two opposed sets of rollers configured and arranged to support a wooden blank and to transport the wooden blank from an infeed end of the apparatus to an outfeed end of the apparatus along a transport path, the wooden blank having a pair of opposed major faces; and
a pair of opposed rotatable cutting heads, configured and arranged to engage the major faces of the wooden blank as it is conveyed through a cutting region of the transport path, wherein each of the cutting heads comprises a plurality of knives, each having a respective irregular profile such that as the wooden blank passes between the cutting heads, a selected profile is imparted to each of the major faces.

2. An apparatus as in claim 1, wherein a first one of the sets of rollers are fixed in a direction perpendicular to the transport path and a second one of the sets of rollers are movable in that direction.

3. An apparatus as in claim 1, wherein a first one of the sets of rollers are driven by one or more motors and a second one of the sets of rollers comprise idler rollers.

4. An apparatus as in claim 3, wherein a first one of the rollers in the set comprising idler rollers is a motor-driven roller.

5. An apparatus as in claim 4, wherein the motor-driven roller is movable in a direction perpendicular to the transport path to engage each wooden blank as it enters the infeed end of the apparatus.

6. An apparatus as in claim 3, wherein the idler rollers are movable in a direction perpendicular to the transport path.

7. An apparatus as in claim 6, wherein each of the movable idler rollers is adjustably movable responsive to a respective actuator.

8. An apparatus as in claim 7, wherein the actuators comprise controllable pistons.

9. An apparatus as in claim 8, wherein the controllable pistons comprise an electronically controlled pneumatic valve.

10. An apparatus as in claim 8, wherein the controllable pistons are controlled by a programmable logic controller system.

11. An apparatus as in claim 1, wherein one of the rotatable cutting heads is a floating cutting head and the other is a fixed cutting head.

12. An apparatus as in claim 11, wherein the fixed cutting head is adjustably positionable relative to the transport path.

13. A method of profiling a shake, comprising:
passing a wooden blank through a pair of opposed rotating cutting heads, configured and arranged to engage opposed major faces of the wooden blank as it is conveyed through a cutting region of a transport path from an infeed end of a cutting apparatus to an outfeed end of the apparatus, wherein each of the cutting heads comprises a plurality of knives, each having a respective irregular profile such that as the wooden blank passes between the cutting heads, a selected profile is imparted to each of the major faces.

14. A method as in claim 13, further comprising, conveying the wooden blank into the cutting region along the transport path into the cutting region from the infeed end to the outfeed end along the transport path.

15. A method as in claim 14, wherein the conveying comprises supporting the wooden blank such that the major faces are presented in a vertical orientation to the cutting heads in the cutting region.

16. An apparatus as in claim 1, wherein at least one of the respective irregular profiles is different from at least one other irregular profile.

17. A method as in claim 13, wherein at least one of the respective irregular profiles is different from at least one other irregular profile.

18. A method as in claim 13, comprising varying a depth of cut as the knives pass through the wooden blank and as the wooden blank passes through the cutting region to produce grooves having a depth that varies along a length of the wooden blank.
